(19) United States
(12) Patent Application Publication
(10) Pub. No.: US 2011/0000688 A1
(43) Pub. Date: Jan. 6, 2011

(54) ELECTRIC ROTATING TOOL, CONTROL METHOD, AND PROGRAM

(76) Inventor: Kazutaka Iwata, Ibaraki (JP)

Correspondence Address: MCDERMOTT WILL & EMERY LLP, 600 13TH STREET, N.W., WASHINGTON, DC, 20005-3096, US

(21) Appl. No.: 12/919,952

(22) PCT Filed: Feb. 16, 2009
(86) PCT No.: PCT/JP2009/053100

§ 371 Date: Aug. 27, 2010

(30) Foreign Application Priority Data
Feb. 29, 2008 (JP) 2008-049540

(51) Int. Cl. B25B 23/147; B25F 5/00; H02P 29/02

(52) U.S. Cl. 173/1; 173/181; 700/170

(57) ABSTRACT

Tightening torque is appropriately managed by a simple means. An electric rotating tool (40) has a brushless DC motor (2), an inverter circuit part (3), and a control circuit part (4). The control circuit part (4) has a current detecting circuit (18), which detects a motor current I, a rotation number detecting circuit (17), which detects the number of rotations of the motor (N), and a computing part (19), which calculates first tightening torque (T1) based on the detection information of the motor current (I) and calculates second tightening torque (T2) based on the number of rotations of the motor (N). The computing part (19) estimates tightening torque Tave based on the estimate value of the first tightening torque (T1) or the second tightening torque (T2). The computing part (19) stops driving the motor (2) when the estimated tightening torque Tave exceeds a set value Tset.

### TECHNICAL FIELD

The present invention relates to an electric rotating tool which requires setting of tightening torque such as a driver, an impact driver, or a driver drill which carries out screw tightening of a bolt, a nut, etc. and, in particular, to the electric rotating tool having torque detection techniques for detecting the tightening torque which is transmitted from an output shaft of a drive source such as an electric motor to a tip tool.

### BACKGROUND ART

Conventionally, in a tightening operation of a fastener such as a bolt, nut, or screw, an electric rotating tool such as an impact driver or a driver drill is used. In the electric rotating tool, in order to appropriately adjust tightening torque that is transmitted from an electric motor to a tip tool such as a driver bit and required for screw tightening, when the fastening torque at the tip tool exceeds a set value, operation of a drive source including the electric motor is stopped, or transmission of the power from the drive source to the tip tool is mechanically disconnected.

In order to manage the tightening torque in the above described manner, the electric rotating tool needs a torque detection means or a torque estimation means, which detects or estimates the tightening torque of an output shaft or a power output shaft of the electric motor. Therefore, conventionally, an electric rotating tool which actually measures tightening torque and controls a motor by providing a torque measurement means, which has a torque detection sensor on a rotation output shaft of a drive mechanism part including the electric motor, and a control circuit means, which drives/controls the electric motor based on torque detection signals of the torque measurement means, is disclosed (for example, see Patent Literature 1).

[Patent Literature 1] Unexamined Japanese Patent Application KOKAI Publication No. H11-138459

### SUMMARY OF INVENTION

In the electric rotating tool, when the torque measurement means is provided on the rotation output shaft of the drive mechanism part, the tightening torque can be accurately detected. However, in the torque measurement means, a mechanism part of the drive output shaft included therein is large; therefore, the overall length of the electric rotating tool or the outer periphery of the tip-tool side is inevitably increased, and the total weight is increased. When the size and the weight of the electric rotating tool are increased, the usability or operability of the electric rotating tool is lowered. Moreover, since a special torque detector and a detection circuit device are required in order to detect torque, manufacturing cost of the electric rotating tool is also increased.

The present invention has been accomplished in order to solve the problems of the above described conventional technique, and an object of the present invention is to provide an electric rotating tool, control method, and program capable of appropriately managing tightening torque by a simple means.

Another object of the present invention is to provide an electric rotating tool, control method, and program having an electronic clutch function, which stops an electric motor as a drive source when tightening torque exceeds set torque.

Typical characteristics of the invention disclosed in the present application in order to achieve the above described objects of the present invention will be explained below.

An electric rotating tool according to a first aspect of the present invention has:

an operating part;

a power source part;

a motor having a rotor and a stator coil;

an inverter circuit part which has a semiconductor switching element inserted between the power source part and the stator coil;

a current detection part which detects a drive current, which flows through the stator coil, and outputs a signal corresponding to a result of the detection;

a rotation number detection part which detects the number of rotations of the rotor and outputs a signal corresponding to a result of the detection;

a torque setting part which sets a target value of tightening torque;

a control part which generates and outputs a PWM signal for driving the semiconductor switching element of the inverter circuit part based on an operated degree of the operating part, the detection signal of the current detection part, and the detection signal of the rotation number detection part; and

a torque estimating part which estimates tightening torque based on at least either one of the drive current, which is detected by the current detection part, and the number of rotations, which is detected by the rotation number detection part; wherein

the control part

stops driving the motor when the estimated tightening torque exceeds the target value.

According to another characteristic of the present invention,

the torque estimating part calculates first tightening torque based on the detected drive current,

calculates second tightening torque based on the detected number of rotations, and

calculates an estimate value of the final tightening torque based on the first tightening torque and the second tightening torque.

According to further another characteristic of the present invention,

the torque estimating part calculates an average value of the first tightening torque and the second tightening torque as the estimate value of the tightening torque.

According to further another characteristic of the present invention,

the control part adjusts the current, which flows through the stator coil, and the rotation of the rotor by adjusting the PWM duty of the PWM signal.

According to further another characteristic of the present invention,

the control part adjusts the PWM duty while comparing the PWM duty with a set value of the PWM duty of the PWM signal corresponding to the target value of the tightening torque, which is set by the torque setting part.

According to further another characteristic of the present invention,

the control part controls the tightening torque by changing the magnitude of the PWM duty while comparing the PWM duty with a set value of the PWM duty corresponding to the target value of the tightening torque, which is set by the torque setting part.

According to further another characteristic of the present invention,

the control part changes the PWM duty of the PWM signal in accordance with the operated degree of the operating part.

According to the further another characteristic of the present invention,

the electric rotating tool is a driver drill, a drill, an impact driver, a driver, or a disk grinder.

According to further another characteristic of the present invention, the battery pack has a secondary battery.

According to further another characteristic of the present invention, the battery pack has a lithium-ion secondary battery.

A control method according to a second aspect of the present invention is

a control method of an electric rotating tool comprising an operating part; a power source part; a motor having a rotor and a stator coil; an inverter circuit part which has a semiconductor switching element inserted between the power source part and the stator coil; and a control part which generates and outputs a PWM signal for driving the semiconductor switching element of the inverter circuit part; the control method characterized by including:

a first step of setting a target value of tightening torque;

a second step of detecting the drive current which flows through the stator coil;

a third step of detecting the number of rotations of the rotor;

a fourth step of estimating tightening torque based on at least either one of the detected drive current and the detected number of rotations; and

a fifth step of causing the control part to stop driving the motor when the estimated tightening torque exceeds the target value.

A program according to a third aspect of the present invention is

a program which causes a computer to control an electric rotating tool comprising an operating part; a power source part; a motor having a rotor and a stator coil; an inverter circuit part which has a semiconductor switching element inserted between the power source part and the stator coil; and a control part which generates and outputs a PWM signal for driving the semiconductor switching element of the inverter circuit part; wherein the program causes the computer to execute

a first procedure of setting a target value of tightening torque;

a second procedure of detecting a drive current, which flows through the stator coil;

a third procedure of detecting the number of rotations of the rotor;

a fourth procedure of estimating tightening torque based on at least either one of the detected drive current and the detected number of rotations; and

a fifth procedure of causing the control part to stop driving the motor when the estimated tightening torque exceeds the target value.

According to the above described invention, the tightening torque is estimated from at least either one of the current, which flows through the stator coil and detected by the current detection part, and the number of rotations of the rotor, which is detected by the rotation number detection part; therefore, the tightening torque can be controlled without attaching a torque detecting device, which actually detects the tightening torque. More specifically, according to the present invention, the tightening torque is estimated based on the current flowing through the stator coil or the number of rotations of the rotor; and, when the estimate value exceeds the target value, transmission of the rotation torque (tightening torque) of the motor to the output shaft of the tip tool is interrupted, thereby realizing an electronic clutch function.

According to above described another configuration of the present invention, the first tightening torque is calculated based on the detected current, which flows through the stator coil, and the second tightening torque is calculated based on the detected number of rotations of the rotor. Then, based on the first tightening torque and the second tightening torque, tightening torque is determined. Therefore, actual tightening torque can be approximated by the estimate value of the tightening torque.

According to above described further another configuration of the present invention, the current, which flows through the stator coil, and the number of rotations of the rotor are controlled by adjusting the PWM duty of the PWM signal; therefore, the tightening torque can be readily controlled. Particularly, the present invention is suitable for an electric rotating tool in which a brushless DC motor capable of controlling a wide range of rotation speed by varying the PWM duty is used as a drive power source.

Furthermore, according to the above described present invention, the motor can be driven by the tightening torque that is within the range which does not cause burnout of the motor; therefore, power consumption of the battery pack due to interruption of operations can be reduced.

Moreover, according to the above described invention, torque management is carried out by the tightening torque in accordance with the load state or the PWM duty of the PWM signal; therefore, efficiency of the workload per one time of charge of the battery pack can be improved.

Further other objects of the present invention and further other novel characteristics of the present invention will be further elucidated by below descriptions of the present description and appended drawings.

### BRIEF DESCRIPTION OF DRAWINGS

FIG. 1 is an overall structure drawing of a driver drill according to an embodiment of the present invention;

FIG. 2 is a cross sectional drawing of a motor along a line A-A of FIG. 1;

FIG. 3 is a functional block diagram of the driver drill of FIG. 1;

FIG. 4 is a characteristic diagram showing a relation between a pressed distance of a switch trigger and a PWM duty in the driver drill shown in FIG. 1;

FIG. 5 is a control flow chart according to the embodiment of the present invention of an electric rotating tool shown in FIG. 3;

FIG. 6 is a characteristic diagram showing a relation between a motor current and an estimate value of first tightening torque; and

FIG. 7 is a characteristic diagram showing a relation between a number of rotations of the motor and an estimate value of second tightening torque.

### BEST MODE FOR CARRYING OUT THE INVENTION

Hereinafter, an embodiment of the present invention will be explained in detail based on drawings. Note that, in all the drawings for explaining the embodiment, the members having the same functions are denoted by the same reference numerals, and repetitive explanations thereof will be omitted.

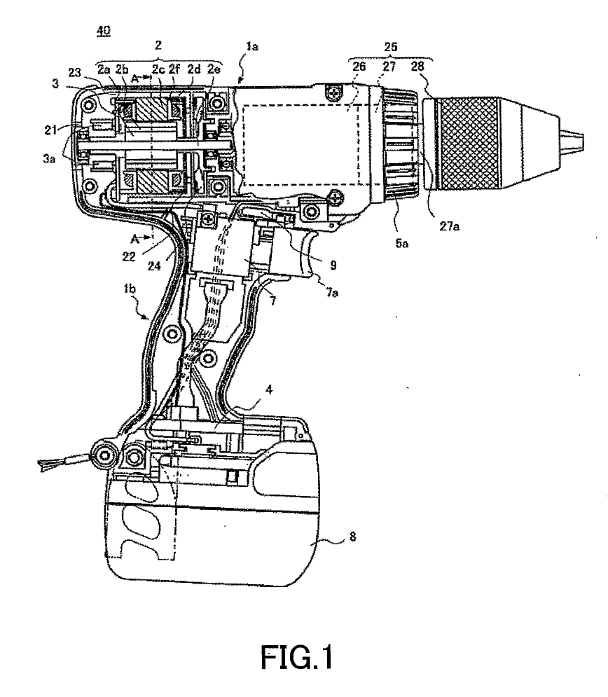

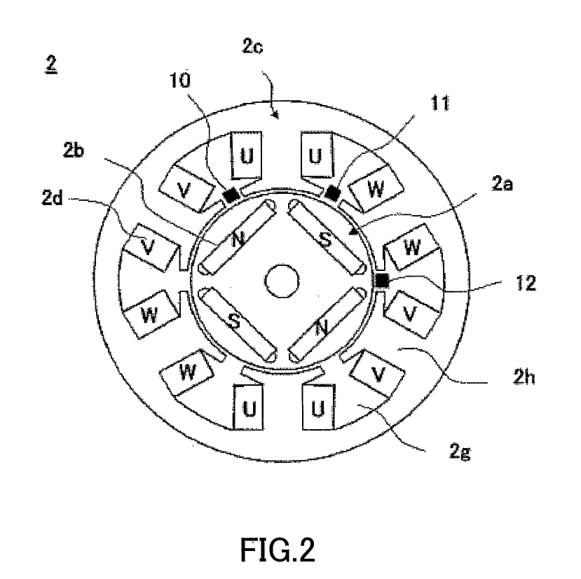

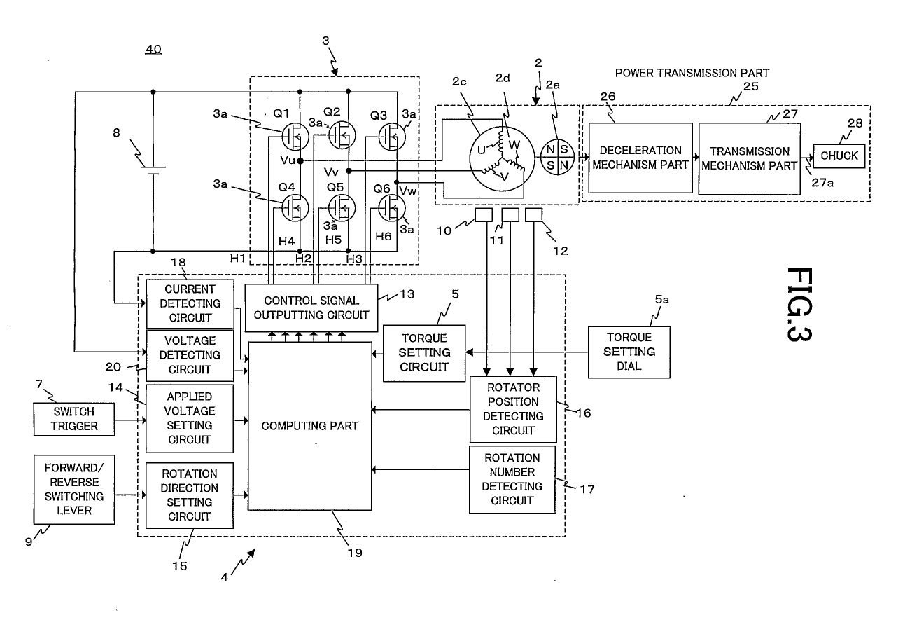

FIG. 1 is an overall structure drawing of a cordless-type driver drill according to an embodiment of the present invention. FIG. 2 is a cross-sectional drawing of a motor of the driver drill along a line A-A shown in FIG. 1. Furthermore, FIG. 3 is a functional block diagram showing the entirety of the driver drill shown in FIG. 1.

[Assembly Configuration of Electric Rotating Tool]

As shown in FIG. 1, a motor 2 is housed in a body housing part 1a of the driver drill 40. A tip tool such as a driver or a drill (not shown) is connected to the motor 2 via a power transmission part 25. The power transmission part 25 transmits the driving force of the motor 2 to the tip tool such as the driver or the drill (not shown). The motor 2 is driven by an inverter circuit part (circuit board) 3. The inverter circuit part 3 is housed in a left-side end part (left side of the motor 2) in the body housing part 1a.

The power transmission part 25 will be explained in further detail. The power transmission part 25 has a deceleration mechanism part 26 and a transmission mechanism part 27. A rotation output shaft 2e of the motor 2 is connected to the deceleration mechanism part 26. The deceleration mechanism part 26 transmits the rotating force of the motor 2 in the direction of the rotation output shaft 2e and reduces the number of rotations thereof. The deceleration mechanism part 26 is housed in an intermediate part of the body housing part 1a.

The transmission mechanism part 27 is connected to the deceleration mechanism part 26. The transmission mechanism part 27 transmits the rotary torque, which is generated at an output shaft of the deceleration mechanism part 26, to a spindle 27a. The transmission mechanism part 27 is housed in a right-end side of the body housing part 1a. Note that a normal impact mechanism part may be provided at the transmission mechanism part 27.

The spindle 27a is an output shaft connected to the transmission mechanism part 27. A chuck 28 is connected to the spindle 27a. A tip tool is detachably held by the chuck 28. The rotating force of the motor 2 generated by drive by the inverter circuit part 3 is applied to the tip tool via the deceleration mechanism part 26, the transmission mechanism part 27, the spindle 27a, and the chuck 28.

A torque setting dial 5a is set at a right-end part of the body housing part 1a. The torque setting dial 5a is configured to electrically set tightening torque. As shown in FIG. 3, a set detection voltage is input to a torque setting circuit 5. The output of the torque setting circuit 5 is input to a computing part 19, which will be described later, and used as a control signal of, for example, the number of rotations of the motor 2 in the computing part 19. The torque setting dial 5a can set, for example, ten levels of tightening torque corresponding to the magnitude of load torque and outputs ten levels of electric signals corresponding to the set tightening torque. The torque setting dial 5a is comprised of, for example, a potentiometer. In the present embodiment, the torque setting dial 5a is installed at the right-end part of the body housing part 1a; however, it may be installed in the vicinity of a control circuit part 4 in a handle housing part 1b.

If the load torque that is equal to or more than the tightening torque that is set by the torque setting dial 5a is applied to the spindle 27a, as is described later, the motor current that flows to the motor 2 and the inverter circuit part 3 is stopped, and the operation of the power transmission part (rotary drive part) 25 including the deceleration mechanism part 26 is stopped. As a result, burnout of the motor 2 and the inverter circuit part 3 with respect to an excessive load current can be prevented. A main object of an electronic clutch function is originally to carry out gradual torque control; however, an electronic clutch function realized by the driver drill 40 according to the present embodiment is provided in order to protect against the excessive load current.

The deceleration mechanism part 26 has, for example, a two-stage planetary gear deceleration mechanism (speed change gear case) (not shown) which is meshed with a pinion gear of the rotation output shaft 2e of the motor 2.

The motor 2 and the inverter circuit 3 constitute a three-phase brushless DC motor. As shown in FIG. 2, the motor 2 has a stator 2c, a rotor (magnet rotor) 2a, and a stator coil (armature coil) 2d. The stator 2c has a cylindrical outer shape, thereby forming a stator yoke. On an inner peripheral side surface of the stator 2c, teeth portions 2h are provided.

The rotor 2a is concentrically provided in an inner peripheral part of the teeth portions 2h of the stator 2c. The rotor 2a is a rotator of an inner magnet layout type in which north-pole and south-pole permanent magnets (magnets) 2b extending in the direction of the rotation output shaft 2e are embedded.

The stator coil 2d is three-phase coils U, V, and W. Hereinafter, the stator coil 2d is also referred to as stator coils 2d (U, V, W). The stator coils 2d (U, V, W) are wound in slots 2g via an insulting layer 2f comprising a resin material so as to surround the teeth portions 2h of the stator 2c. The stator coils 2d (U, V, W) are in star connection.

In the vicinities of the rotor 2a, in order to detect the rotation position of the rotor 2a, three rotation position detecting elements (hall ICs) 10, 11, and 12 (see FIG. 3) are disposed with an interval of 60° in the rotation direction.

Position detection signals of the rotation position detecting elements 10, 11, and 12 are output to a control circuit part 4. The control circuit part 4 controls the inverter circuit 3 based on the input position detection signals. As a result of this control, a current that is controlled to a power-distribution range of an electric angle of 120° is supplied to the stator coils 2d (U, V, W).

Note that elements which detect the rotation position by the hall ICs in an electromagnetically-coupling manner are employed as the rotation position detecting elements 10, 11, and 12. However, as the rotation position detecting elements 10, 11, and 12, it is also possible to employ sensorless-type elements which detect the rotor position by extracting the induced voltages (back electromotive force) of the stator coils 2d (U, V, W) as logic signals through a filter.

As shown in FIG. 1, the body housing part 1a comprises a synthetic resin material and is integrally formed with a handle housing part 1b. The body housing part 1a and the handle housing part 1b are divided into two by a vertical plane (the cross section of the partial cross sectional drawing of FIG. 1) along the rotation axis of the motor 2. In other words, a pair of parts each of which having a semicircular cross sectional shape is prepared as the integrally formed body housing part 1a and handle housing part 1b. After housed objects such as the rotor rotation shaft 2e and the stator 2c of the motor 2 are incorporated in the body housing part 1a and the handle housing part 1b of one side, the body housing part 1a and the handle housing part 1b of the other side are superimposed thereon, and both of them are joined by screw fastening, etc; thus, assembling of the driver drill is completed.

In the joined body (completed body) of the pair of the body housing part 1a and the handle housing part 1b, the outer peripheral surface of the stator 2c is held or sandwiched by a plurality of stator holding portions (rib portions) which are integrally formed with the body housing part 1a.

A cooling fan 24 is provided in a right-end side of the motor 2. Although it is not illustrated, an air-discharge opening (ventilation opening) is formed on the body housing part 1a in the vicinity of the cooling fan 24. Meanwhile, an air-intake opening (ventilation opening) 21 is formed at a left end of the body housing part 1a. A path 23 which is formed from the air-intake opening 21 to the air-discharge opening formed in the vicinity of the cooling fan 24 is a flow path of cooling air. The path 23 suppresses the temperature increase of the semiconductor switching elements 3a in the inverter circuit part 3 and the temperature increase of the stator coils 2d in the motor 2. Particularly, in the driver mode or the drill mode, a large current flows to the semiconductor switching elements 3a depending on the load state of the motor 2, and the heating value of the semiconductor switching elements 3a becomes large; therefore, the inverter circuit part 3 has to be forcibly cooled by air by the cooling fan 24.

Note that the inverter circuit part 3 comprises a circular circuit board and thoroughly covers one end side of the stator 2c of the motor 2. Meanwhile, a dust preventing cover 22 is provided in the other end side of the stator 2c. As well as the inverter circuit part 3, the dust preventing cover 22 covers the other end-side surface of the stator 2c. Both the inverter circuit part 3 and the dust preventing cover 22 have dust-preventing structures (sealing structures) that close or seal the rotor 2a together with the stator 2c. Thus, incoming of dust into the motor 2 can be prevented.

A battery pack 8 which serves as a drive power source of the motor 2 is detachably attached to a lower end part of the handle housing part 1b. To an upper part of the battery pack 8, the control circuit part (circuit board) 4 for controlling the inverter circuit part 3 is provided to extend in the transverse direction of the page.

A switch trigger 7 is disposed in an upper end part of the handle housing part 1b. A trigger operating part 7a of the switch trigger 7 is projecting from the handle housing part 1b in the state that it is biased by spring force. When an operator grips the trigger operating part 7a in an inward direction of the handle housing part 1b against the spring force, the trigger pressed distance (operating degree) is adjusted. The number of rotations of the motor 2 is controlled by the trigger pressed distance. According to the present embodiment, the pulse-width modulation duty (PWM duty) of a PWM signal which drives the semiconductor switching elements 3a of the inverter circuit part 3 is varied in accordance with the trigger pressed distance; therefore, the switch trigger 7 and an applied voltage setting circuit 14 (see FIG. 3), which will be described later, are electrically connected to each other.

In order to supply drive power to the switch trigger 7, the control circuit part 4, and the inverter circuit part 3, the battery pack 8 is electrically connected therewith. A secondary battery is used as a battery of the battery pack 8. For example, a lithium-ion battery is used as the secondary battery. The power supply voltage of the lithium-ion battery is set to, for example, 14.4 V. The lithium-ion battery has advantages that the battery has an energy density about three times higher compared with a nickel cadmium battery or a nickel hydride battery and that the battery is small and has a light weight. Consequently, the part required for housing the battery pack 8 in the handle housing part 1b can be downsized. As a result, the need to house the battery pack 8 in a gripping part of the handle housing part 1b is eliminated; therefore, the length of the outer periphery of the gripping part can be formed to be shorter compared with the cases in which other battery types are used. As a result, the shape of the gripping part can be caused to be a handle shape that can be easily gripped.

[Circuit Configuration of Electric Rotating Tool]

The circuit configuration of the motor 2, the inverter circuit part 3, and the control circuit part 4 will be explained with reference to FIG. 3.

The inverter circuit part (power inverter) 3 has six semiconductor switching elements 3a which are connected in the three-phase bridge method. As the semiconductor switching elements 3a, insulated-gate bipolar transistors (IGBT) can be used. These six semiconductor switching elements 3a are also referred to as transistors Q1 to Q6.

The combination of the transistors Q1 and Q4, the combination of the transistors Q2 and Q5, and the combination of the transistors Q3 and Q6 are in bridge connection in three phases between the positive electrode and the negative electrode of the battery pack (DC power source) 8. The collectors or emitters of the transistors Q1 to Q6 are connected to the stator coils 2d (U, V, W) of the motor 2 which are in star connection.

The gates of the transistors Q1 to Q6 are connected to the control circuit part 4. The control circuit part 4 outputs corresponding PWM signals H1 to H6 to the gates of the six transistors Q1 to Q6. Switching operations of the six transistors Q1 to Q6 are carried out by the PWM signals H1 to H6. The DC voltage of the battery pack 8 applied to the inverter circuit part 3 is converted to drive voltages Vu, Vv, and Vw of three phases (U phase, V phase, and W phase) by the switching operations. The drive voltages Vu, Vv, and Vw of the three phases (U phase, V phase, and W phase) are applied to the stator coils 2d (U, V, W) of the motor 2, respectively.

The control circuit part 4 drives the inverter circuit part 3. The control circuit part 4 has a rotator position detection part 16, a rotation number detecting circuit 17, a current detecting circuit 18, a voltage detecting circuit 20, the applied voltage setting circuit 14, a rotation direction setting circuit 15, the torque setting circuit 5, the computing part 19, and a control signal outputting circuit 13.

The rotator position detecting circuit 16 detects the rotation position of the rotor 2a with respect to the stator coils 2d (U, V, W) of the stator 2c based on output signals of the rotation position detecting elements 10, 11, and 12. The detected rotation position of the rotor 2a is output to the computing part 19.

The rotation number detecting circuit 17 detects the number of rotations of the motor 2 (rotor) based on the time intervals of the signals output from the rotation position detecting elements 10, 11, and 12. The detected number of rotations of the motor 2 is output to the computing part 19.

The current detecting circuit 18 is always detecting the drive current of the motor 2 (current that flows through the stator coil 2d). The detected current value is output to the computing part 19.

The voltage detecting circuit 20 is always detecting the power supply voltage that is supplied from the battery pack 8 to the stator coil 2d of the motor 2.

The applied voltage setting circuit 14 sets the duty rate of the pulse width of the PWM signal corresponding to a control signal output from the switch trigger 7 (hereinafter, referred to as “PWM duty”) in accordance with the trigger pressed distance by the trigger operating part 7a of the switch trigger 7.

The rotation direction setting circuit 15 detects whether the rotation direction of the motor 2 (rotor 2a) set by a forward/reverse switching lever 9 (see FIG. 1) is a forward direction or a reverse direction and sets the rotation direction of the motor 2 (rotor 2a) based on the detection result. The rotation direction setting circuit 15 outputs a rotation direction setting signal including the information of the set rotation direction to the computing part 19.

The torque setting circuit 5 inputs the detection signal of the above described torque setting dial 5a and outputs the set value of the tightening torque to the computing part 19.

Based on the output information of the current detecting circuit 18, the voltage detecting circuit 20, and the applied voltage setting circuit 14, the computing part 19 generates drive signals, i.e., PWM signals for the switching elements Q1 to Q6 of the inverter circuit part 3 and outputs the signals, thereby controlling the voltages Vu, Vv, and Vw applied to the motor 2.

Moreover, the computing part 19 switches the predetermined switching elements Q1 to Q6 in a predetermined order based on the information output from the rotation direction setting circuit 15 and the rotator position detecting circuit 16. Consequently, the applied voltages Vu, Vv, and Vw are supplied to the stator coils 5d (U, V, W) in a predetermined order, and, as a result, the motor 2 rotates in the set rotation direction.

Moreover, the computing part 19 controls activation or stop of drive of the motor 2 based on the output information of the torque setting circuit 5.

The computing part 19 is a microcomputer and has ROM, CPU, RAM, various types of timers, etc. (all of them are not shown). The ROM stores processing programs, which execute later-described control flows, and control data. The CPU executes such a processing program and generates above described drive signals. The RAM stores data temporarily. The timers count time.

The computing part 19 uses the drive signals input to the gates of the semiconductor switching elements Q4, Q5, and Q6 of the negative power source side as pulse width modulation signals (PWM signals) H4, H5, and H6 among the drive signals (three-phase signals) input to the gates of the six semiconductor switching elements 3a (Q1 to Q6). Then, the computing part 19 varies the PWM duties of the PWM signals based on the output signal of the applied voltage setting circuit 14 corresponding to the trigger pressed distance of the trigger operating part 7a of the switch trigger 7 (see FIG. 1), thereby adjusting the power for the motor 2 and carrying out activation and speed control of the motor 2.

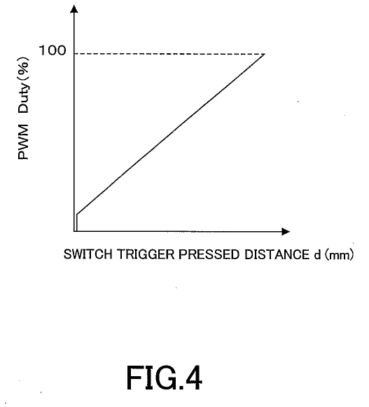

An example of the relation between the trigger pressed distance d of the trigger operating part 7a of the switch trigger 7 and the PWM duty (PWM DUTY) is shown in FIG. 4.

Note that, instead of using the drive signals input to the gates of the semiconductor switching elements Q4, Q5, and Q6 of the negative power source side as the PWM signals, drive signals H1 to H3 input to the gates of the semiconductor switching elements Q1, Q2, and Q3 of the positive power source side may be used as PWM signals. Even in this case, as a result, the DC voltage of the battery pack 8 can be converted to the applied voltages Vu, Vv, and Vw which are supplied to the stator coils 5d (U, V, W).

The control signal outputting circuit 13 converts the drive signals output from the computing part 19 to the control signals (voltage signals) which are actually input to the gates of the switching elements Q1 to Q6 and outputs the signals.

The control circuit part 4 generates the drive signals H1 to H6 by using the above described configuration based on the rotation direction setting signal output from the rotation direction setting circuit 15, the rotation position detection signal output from the rotator position detecting circuit 16, the rotation number detection signal output from the rotation number detecting circuit 17, the motor current detection signal output from the current detecting circuit 18, the power supply voltage detection signal output from the voltage detecting circuit 20, and the PWM duty setting signal output from the applied voltage setting circuit 14.

The control signals control the switching operations of the semiconductor switching elements Q1 to Q6, and a three-phase AC voltage is applied to the stator coils 5d (U, V, W) of the motor 2.

The motor 2 is activated or stopped by this control of the control circuit part 4. Also, the control circuit part 4 adjusts the PWM duties of part of the drive signals among the drive signals H1 to H6, thereby controlling the motor current and the number of rotations of the motor (rotation speed).

[Control Flow for Tightening Torque Detection of Electric Rotating Tool]

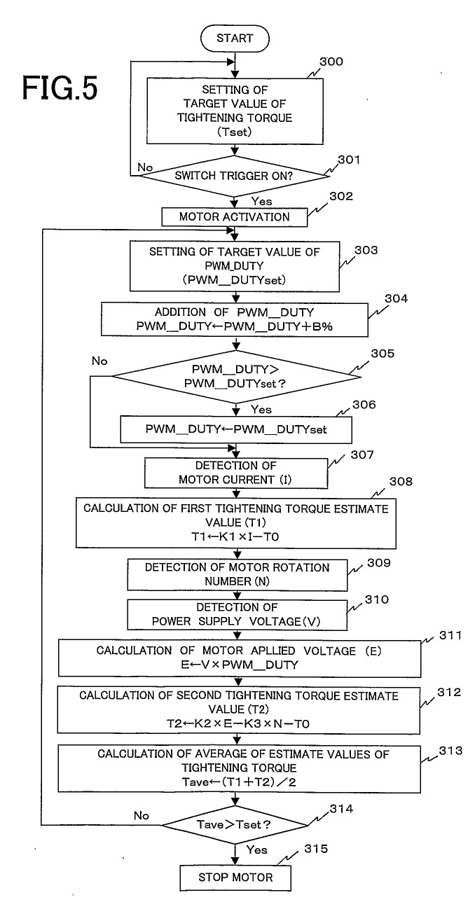

A control flow of the case in which a screw tightening operation of, for example, a bolt or a nut is carried out by the electric rotating tool 40 will be explained below with reference to FIG. 5.

First, when desired tightening torque (Tset) corresponding to the magnitude (load state) of the screw tightening torque of, for example, the bolt or the nut is set by the torque setting dial 5a, the output of the torque setting dial 5a is input to the torque setting circuit 5, and the set value is stored in a memory part (RAM) of the computing part 19 (step 300).

Next, the computing part 19 waits until an operator pulls the switch trigger 7 (trigger operating part 7a) so as to turn on the switch trigger 7 (step 301). Until that point, the target value Tset of the tightening torque is repeatedly set. When the switch trigger 7 is turned on (Yes in step 301), the computing part 19 activates the motor 2 (step 302).

Next, the computing part 19 sets a target value (PWM_DUTYset) of the PWM duty (PWM_DUTY) of each of the PWM drive signals (H1 to H6) based on the trigger operated degree (trigger pulled degree) of the trigger operating part 7a of the switch trigger 7 (step 303). The target value PWM_DUTYset of the PWM duty is set in accordance with the target value Tset of the tightening torque, which is set in above described step 300. Note that the value per se of the target value PWM_DUTYset of the PWM duty is determined by the operated degree of the operating part of the switch trigger 7 and is set regardless of the above described target tightening torque Tset.

Next, the computing part 19 carries out addition of the PWM duty so that the PWM duty (PWM_DUTY) of the detected PWM drive signal becomes the set target value PWM_DUTYset of the PWM duty (step 304). In this addition, a certain rate with respect to the current PWM_DUTY (hereinafter, abbreviated as “PWM_DUTY”), for example, B% (B is a real number larger than 1 and smaller than 100) is added.

The computing part 19 determines whether the PWM duty (PWM_DUTY) based on the trigger operated degree (trigger pulled degree) of the trigger operating part 7a has exceeded the target value PWM_DUTYset of the PWM duty or not (step 305). When the PWM_DUTY is exceeding the target value PWM_DUTYset of the PWM duty (Yes in step 305), the computing part 19 updates PWM_DUTY to PWM_DUTYset (step 306).

When PWM_DUTY is updated to PWM_DUTYset (step 306) or PWM_DUTY is determined to be smaller than PWM_DUTYset (No in step 305), the computing part 19 detects the motor current I (step 307).

Subsequently, the computing part 19 calculates an estimate value of first tightening torque T1 based on the detected motor current I of the motor 2 (stator coil 2d) (step 308). The first tightening torque T1 is calculated by multiplying the motor current I by a torque characteristic constant K1 of the motor and subtracting loss torque T0 from the multiplied value (K1×I). The calculation formula is shown below.

T1=K1×I−T0 (1)

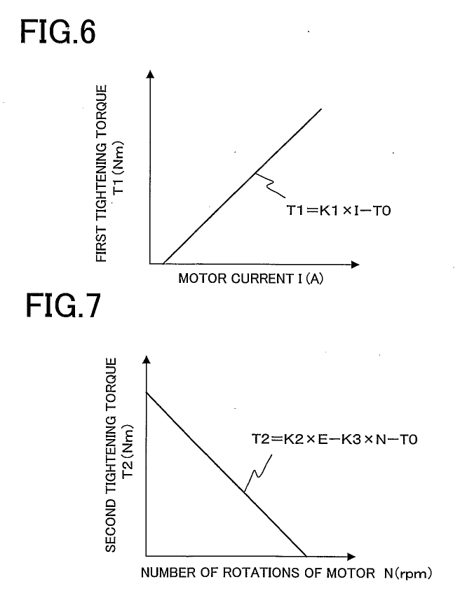

FIG. 6 shows the relation between the motor current I and the estimated first tightening torque T1. This relation is stored in the memory part (ROM) of the computing part 19 in advance.

Subsequently, the computing part 19 detects the number of rotations N of the motor 2 by the rotation number detecting circuit 17 (step 309).

Next, the computing part 19 detects the power supply voltage V, which is supplied from the battery pack 8 to the motor 2, by the voltage detecting circuit 20 (step 310) and calculates a motor applied voltage E, which is applied to the motor 2 (stator coil 2d), based on the detected voltage V and PWM_DUTY and using the below formula (step 311).

E=V×PWM_DUTY (2)

Furthermore, the computing part 19 calculates an estimate value T2 of second tightening torque based on the detected number of rotations N and the calculated motor applied voltage E (step 312). The estimate value T2 of the second tightening torque is calculated by subtracting the value, which is obtained by multiplying the number of rotations N by a torque characteristic constant K3, and the loss torque T0 from the value, which is obtained by multiplying the motor applied voltage E by a torque characteristic constant K2. The calculation formula thereof is shown below.

T2=K2×E−K3×N−T0 (3)

FIG. 7 shows the relation between the motor rotation number N and the estimated second tightening torque T2. This relation is also stored in the memory part (ROM) of the computing part 19 in advance as well as the first tightening torque T1.

Next, the computing part 19 obtains an average value Tave of the above described estimate value T1 of the first tightening torque and the above described second tightening torque T2 by using the next formula (step 313).

Tave=(T1+T2)/2 (4)

Next, the computing part 19 determines whether the above described tightening torque Tave has exceeded the initially set tightening torque Tset (set target value PWM_DUTYset) or not (step 314). When it has exceeded the target value (Yes in step 314), the computing part 19 stops driving the motor 2 (step 315). As a result, in the course of tightening of the screw such as the bolt or nut with respect to a tightened member, crashing of the screw and occurrence of excessive tightening can be prevented. When it has not exceeded the target value Tset (No in step 314), the computing part 19 returns to step 303. Thereafter, the above described operations are repeated until it reaches the predetermined tightening torque.

According to the above described embodiment, the tightening torque is estimated by the average value (T1+T2)/2 of the first tightening torque T1, which is calculated based on the motor current I, and the second tightening torque T2, which is calculated based on the number of rotations of the motor N. Therefore, actual tightening torque can be approximated by the estimate value. The estimated tightening torque is gradually varied.

Moreover, in the above described embodiment, either one of the above described first tightening torque T1, which is calculated based on the motor current I, and the above described second tightening torque T2, which is calculated based on the number of rotations of the motor N, may be directly considered as the tightening torque so as to be compared with the target value Tset of the tightening torque which is set in advance. However, when the above described first tightening torque T1 and the above described second tightening torque T2 are compared with the average value Tave thereof, they are largely deviated from the actual tightening torque. Therefore, this method can be subjected to actual use when the set tightening torque Tset is comparatively large and such deviation can be ignored.

Moreover, according to the above described embodiment, the tightening torque is estimated based on the current I, which flows through the stator coil 2a of the motor 2 and detected by the current detecting circuit 18, and the number of rotations (N) of the rotor 2a of the motor 2, which is detected by the rotation number detecting circuit 17. Therefore, the tightening torque can be controlled without attaching a torque detecting device which actually detects the tightening torque.

Moreover, according to the above described embodiment, the tightening torque is controlled in accordance with the PWM duty (PWM_DUTY) of the PWM signal of the motor 2. Moreover, since the motor current (current flowing through the coil stator 2d) and the number of rotations of the motor (number of rotations of the rotor 2a) are controlled by varying the PWM duty, the tightening torque can be appropriately controlled. Particularly, the present embodiment is suitable for an electric rotating tool in which a brushless DC motor capable of controlling a wide range of rotation speed by varying the PWM duty is used as a drive power source.

Furthermore, according to the above described embodiment, the motor 2 is driven while the tightening torque that is within the range which does not cause burnout of the motor 2 is set; therefore, power consumption of the battery pack 8 caused by interruption of operations can be reduced. Moreover, according to the above described embodiment, since the tightening torque is controlled in accordance with the load state or the PWM duty of the PWM signal, efficiency of the workload per one time of charge of the battery pack 8 can be improved.

Note that, in the above described embodiment, the case in which the three-phase brushless DC motor is used as the motor 2 has been explained; however, a brushless DC motor other than that of three phases can be used. Also, the present invention can be applied to another electric rotating tool such as a drill, driver, impact driver, disk grinder, other than the driver drill 40 explained in the above described embodiment. Furthermore, although the lithium ion battery is used as the battery (secondary battery) of the battery pack 8 of the electric rotating tool, another secondary battery such as a nickel-cadmium battery, nickel hydride battery can be used. However, when the lithium ion battery is used, the battery pack can be downsized, the weight thereof can be reduced, and improvement of the operating efficiency of the electric rotating tool and improvement of operability by virtue of downsizing and weight-reduction can be expected.

The present invention has been explained above in detail based on the embodiment; however, the present invention is not limited to the above described embodiment, and various modifications can be made within the range that does not depart from the gist of the invention.

This application is based on Japanese Patent Application Publication No. 2008-049540 filed on Feb. 29, 2008. The specification, claims, and drawings of the disclosure thereof are expressly incorporated herein in its entirety.

1. An electric rotating tool comprising:
an operating part;
a power source part;
a motor having a rotor and a stator coil;
an inverter circuit part which has a semiconductor switching element inserted between the power source part and the stator coil;
a current detection part which detects a drive current, which flows through the stator coil, and outputs a signal corresponding to a result of the detection;
a rotation number detection part which detects the number of rotations of the rotor and outputs a signal corresponding to a result of the detection;
a torque setting part which sets a target value of tightening torque;
a control part which generates and outputs a PWM signal for driving the semiconductor switching element of the inverter circuit part based on an operated degree of the operating part, the detection signal of the current detection part, and the detection signal of the rotation number detection part; and
a torque estimating part which estimates tightening torque based on at least either one of the drive current, which is detected by the current detection part, and the number of rotations, which is detected by the rotation number detection part; wherein
the control part stops driving the motor when the estimated tightening torque exceeds the target value.

2. The electric rotating tool according to claim 1, characterized in that
the torque estimating part calculates first tightening torque based on the detected drive current,
calculates second tightening torque based on the detected number of rotations, and
calculates an estimate value of the tightening torque based on the first tightening torque and the second tightening torque.

3. The electric rotating tool according to claim 2, characterized in that
the torque estimating part calculates an average value of the first tightening torque and the second tightening torque as the estimate value of the tightening torque.

4. The electric rotating tool according to claim 1, characterized in that
the control part adjusts the current, which flows through the stator coil, and the rotation of the rotor by adjusting the PWM duty of the PWM signal.

5. The electric rotating tool according to claim 4, characterized in that
the control part adjusts the PWM duty while comparing the PWM duty with a set value of the PWM duty of the PWM signal corresponding to the target value of the tightening torque, which is set by the torque setting part.

6. The electric rotating tool according to claim 4, characterized in that
the control part controls the tightening torque by changing the magnitude of the PWM duty while comparing the PWM duty with a set value of the PWM duty corresponding to the target value of the tightening torque, which is set by the torque setting part.

7. The electric rotating tool according to claim 4, characterized in that
the control part changes the PWM duty of the PWM signal in accordance with an operated degree of the operating part.

8. The electric rotating tool according to claim 1, characterized in that
the electric rotating tool is a driver drill, a drill, an impact driver, a driver, or a disk grinder.

9. The electric rotating tool according to claim 1, characterized in that the battery pack has a secondary battery.

10. The electric rotating tool according to claim 1, characterized in that the battery pack has a lithium ion secondary battery.

11. A control method of an electric rotating tool comprising: an operating part; a power source part; a motor having a rotor and a stator coil; an inverter circuit part which has a semiconductor switching element inserted between the power source part and the stator coil; and a control part which generates and outputs a PWM signal for driving the semiconductor switching element of the inverter circuit part; the control method including:
a first step of setting a target value of tightening torque;
a second step of detecting a drive current which flows through the stator coil;
a third step of detecting the number of rotations of the rotor;
a fourth step of estimating tightening torque based on at least either one of the detected drive current and the detected number of rotations; and
a fifth step of causing the control part to stop driving the motor when the estimated tightening torque exceeds the target value.

12. A program which causes a computer to control an electric rotating tool comprising: an operating part; a power source part; a motor having a rotor and a stator coil; an inverter circuit part which has a semiconductor switching element inserted between the power source part and the stator coil; and a control part which generates and outputs a PWM signal for driving the semiconductor switching element of the inverter circuit part; wherein the program causes the computer to execute
a first procedure of setting a target value of tightening torque;
a second procedure of detecting the drive current which flows through the stator coil;
a third procedure of detecting the number of rotations of the rotor;
a fourth procedure of estimating tightening torque based on at least either one of the detected drive current and the detected number of rotations; and
a fifth procedure of causing the control part to stop driving the motor when the estimated tightening torque exceeds the target value.
